(19) United States
(12) Patent Application Publication
(10) Pub. No.: US 2011/0307879 A1
(43) Pub. Date: Dec. 15, 2011

(54) PROGRAM UPDATE DEVICE, PROGRAM UPDATE METHOD, AND INFORMATION PROCESSING DEVICE

(75) Inventors: Yasuhisa Ishida, Kobe-shi (JP); Shigehiko Kagotani, Kobe-shi (JP); Hironobu Sugimoto, Chofu-shi (JP); Tomoki Kodan, Nagoya-shi (JP)

(73) Assignees: TOYOTA JIDOSHA KABUSHIKI KAISHA, Toyota-shi, Aichi (JP); FUJITSU TEN LIMITED, Kobe-shi, Hyogo (JP)

(21) Appl. No.: 13/202,857

(22) PCT Filed: Feb. 4, 2010
(86) PCT No.: PCT/JP2010/000674

§ 371 Date: Aug. 23, 2011

(30) Foreign Application Priority Data
Feb. 24, 2009 (JP) 2009-040291

(51) Int. Cl. G06F 9/445; G06F 11/14; G06F 9/44

(52) U.S. Cl. 717/170; 714/2; 714/E11.142

(57) ABSTRACT

A program update device includes: a first storage unit to retain a program of a first version; a second storage unit to retain a program of a second version equal to or later than the first version; an acquiring unit to acquire a difference between the program of the second version and a program of a third version later than the second version; and an update unit to generate the program of the third version from the program of the second version that is stored in the second storage unit and the difference acquired by the acquiring unit, and to store the generated program of the third version in the first storage unit.

### TECHNICAL FIELD

The present invention relates to a program update process.

### BACKGROUND ART

An on-vehicle device mounted with a car navigation system needs to update an application program of map information etc in a way that synchronizes with new constructions of roads. For example, the following two methods are exemplifications of a method of updating a program including an operating system (OS) of the on-vehicle device and an application program (which will hereinafter be generically termed “the program”).

(1) Execution of Update Process by Expert

This is a method by which a user of an owner of the on-vehicle device sends a hard disk (which will hereinafter be abbreviated to HDD (Hard Disk Drive) or the on-vehicle device itself to a maker, and the maker executes the program update process. Alternatively, this is a method by which an automobile is placed in car dealer's custody, and a salesman executes the program update process.

According to this method, the expert executes the program update process, and hence procedures, means, etc of the program update process can be implemented in a freehanded manner to some extent. Advantages in the case of the expert's executing the program update process are, e.g., given as follows.

(A) Selecting whether updating individual programs or updating all of the programs can be performed in the freehanded way. (B) A dedicated connecting device such as a jig employed for the program update process can be used. Further, a storage medium can be taken out by decomposing the device. The update process can be re-executed even if failing to update the program. (C) The data can be backed up. (D) The program can be reset to a factory shipment status by recovery.

The following are, for example, faults in contrast with the advantages described above, which are produced by the expert's executing the program update process.

(a) The user costs time and effort. For example, the on-vehicle device or the HDD must be sent to the maker, or the automobile has a necessity of being placed in the dealer's custody in a way that visits the dealer. (b) The user is disabled from using the car navigation system during a period for which the on-vehicle device, the HDD, or the automobile is placed in the maker's or dealer's custody. (c) The use of the dedicated jig, the decomposition of the device, etc. are operations that can be conducted by only professionals.

(2) Execution of Update Process by User

This is a method by which the user himself or herself executes the program update process by using an update program stored on a CD-ROM (Compact Disk-Read Only memory), a DVD-ROM (Digital Versatile Disc ROM) and other types of storage mediums. Alternatively, this is a method by which the user himself or herself executes the program update process by downloading the update program through communications with the outside in a way that utilizes a communication function etc of a mobile phone or the on-vehicle device. Advantages of the user's executing the program update process are given as below.

(A) The user himself or herself can execute the program update process and has therefore any necessity for neither sending the HDD to the maker nor placing the automobile in the shop's custody.

The following are, for example, faults in contrast with the advantages described above, which are produced by the user's executing the program update process.

(a) The on-vehicle device has no resetting means and therefore has, if failing to execute the program update process, a possibility of getting into a startup-disabled situation in the worst case. (b) In the case of using the CD-ROM, DVD-ROM, etc, it is time-consuming to obtain these ROMs. (c) In the case of downloading the data of the update program by making use of the communication function of the mobile phone or the on-vehicle device, a communication fee such as a packet communication fee occurs. If a data size to be downloaded is large, the communication fee rises, and a considerable period of time is required.

A serious fault to the method by which the user executes the program update process is such a point that there is a possibility of being unable to reset if failing to execute the program update process. A thinkable cause for the failure in the program update process is, for instance, shutdown of a power source (the shutdown of the accessory power source of the automobile) during the program update process.

Accordingly, a desirable program update method is a method enabling the user to execute the program update process and including the reset means if failing to update the program.

### CITATION LIST

### Patent Literature

PTL 1: Japanese Patent Laid-Open Publication No. 2006-301960

### SUMMARY OF INVENTION

### Technical Problem

It is an object of the present invention to provide a program update method capable of making a recovery to a normal operation even in the case of a failure in a program update process.

### Solution to Problem

The present invention adopts the following means in order to solve the problems given above. Namely, a program update device includes: a first storage unit to retain a program of a first version; a second storage unit to retain a program of a second version equal to or later than the first version; an acquiring unit to acquire a difference between the program of the second version and a program of a third version later than the second version; and an update unit to generate the program of the third version from the program of the second version that is stored in the second storage unit and the difference acquired by the acquiring unit, and to store the generated program of the third version in the first storage unit.

According to the present invention, the program of the first version that is stored in the first storage unit is updated into the program of the third version, while the second storage unit continues to retain the program of the second version. For example, in the step of generating the program of the third version or in the step of storing the program of the third version in the first storage unit, even if a power source of a computer is shut down, the program of the second version continues to be stored, and hence the recovery can be made by use of the program of the second version.

Further, according to another mode of the present invention, an information processing device includes: an auxiliary storage device to retain a program of a version set when shipped from a factory and a program of a first version later than the version at the factory shipment time; a main storage device to retain the program of the first version that is loaded from the auxiliary storage device; and a CPU to start up the program of the first version that is retained by the main storage device with power on, wherein the CPU, when an error exists in the program of the first version that is retained by the main storage device and when an operation of the program of the first version that is retained by the main storage device is interrupted a predetermined number of times or more during a period till power on this time, loads the program of the first version that is stored in the auxiliary storage device into the main storage device, and the CPU, when the program of the first version that is retained by the main storage device fails to be loaded a predetermined number of times or more during the period till power on this time, loads the program of the version at the factory shipment time that is stored in the auxiliary storage device into the main storage device.

According to the present invention, even if the abnormality occurs in the program data of the first version that is loaded into the main storage device, it is feasible to make the recovery to the normal status by loading the program of the first version again from the auxiliary storage device. Moreover, even if failing to load the program of the first version from the auxiliary storage device, the device can be started up by using the program of the version in the factory shipment status. Thus, the processes are executed stepwise, the recovery process can be conducted more efficiently. Further, finally, the startup of the device can be guaranteed by the program of the version in the factory shipment status.

### Advantageous Effects of Invention

According to the present invention, it is feasible to provide the program update method capable of making the recovery to the operation in the normal status even in the case of the failure in the program update process.

### BRIEF DESCRIPTION OF DRAWINGS

FIG. 1 is a diagram illustrating an example of an architecture of program update system.

FIG. 2 is a diagram illustrating an example of an operation in a program update process of the program update system.

FIG. 3A is a table illustrating an example of a resetting operation when a power source is down during the program update process.

FIG. 3B is a table illustrating the example of the resetting operation when the power source is down during the program update process.

FIG. 3C is a table illustrating the example of the resetting operation when the power source is down during the program update process.

FIG. 4 is a table illustrating an example of a value of a boot flag in an FROM.

FIG. 5 is a diagram illustrating an example of how recovery data of an on-vehicle device is retained.

FIG. 6 is a diagram illustrating an example of a flow of a startup operation at a normal time.

FIG. 7 is a flowchart illustrating an example of a startup sequence.

FIG. 8 is a diagram illustrating an example of a processing flow executed in a sequence A at an abnormal time.

FIG. 9 is a flowchart illustrating a processing flow executed in the sequence A at the abnormal time.

FIG. 10 is a diagram illustrating an example of a processing flow executed in a sequence B at the abnormal time.

FIG. 11 is a diagram illustrating the example of the processing flow executed in the sequence B at the abnormal time.

### DESCRIPTION OF EMBODIMENTS

Embodiments of the present invention will hereinafter be described with reference to the drawings. Configurations in the following embodiments are exemplifications, and the present invention is not limited to the configurations in the embodiments.

### First Embodiment

A program update method of the present invention involves retaining two folders each including the same program group (which will hereinafter be referred to as “program folders”) on one storage medium of a device. On the occasion of a program update process, a program group in the other program folder is updated, while the program group in another program folder is retained in the status quo as a backup.

The program update processes are executed alternately with respect to the two program folders, whereby one program folder can retain the program group of the latest version by updating the program group. Further, another program folder can retain the program group of a version which has been used just before the update process. After the program update process, if the program (the updated program) of the latest version does not run, the program folder of the program group (retained as the backup) undergoing none of the program update process is selected, thereby the program is from the program folder of the program group retained as the back up to be started up.

### Example of Architecture of Program Update System

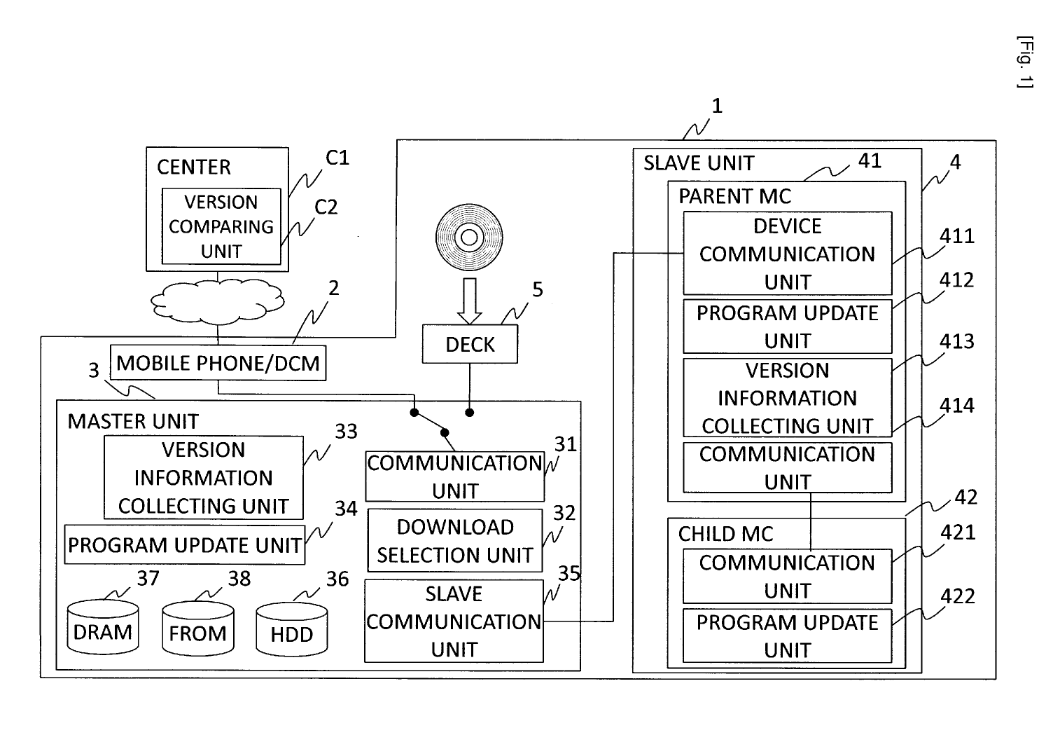

FIG. 1 is a diagram illustrating an example of an architecture of a program update system. The program update system includes an on-vehicle device 1 and retains an update program. For example, the program update system includes a center C1 defined as a server of a maker.

The center C1 is, for example, the server of a maker etc. of the programs installed into the on-vehicle device 1. The center C1 transmits program update information. The center C1 includes a version comparing unit C2. The version comparing unit C2 compares a version of the programs installed into the on-vehicle device 1 with the latest version of the programs retained by the center C1, and generates differential data.

The on-vehicle device 1 is a device equipped with a car navigation system mounted in a user's car. The on-vehicle device 1 includes a mobile phone/DCM (Data Communication Module) 2, a master unit 3, slave units 4, and a deck 5. Note that FIG. 1 illustrates one of the slave units 4.

The mobile phone/DCM 2 is an interface performing wireless communication with the external center C1. In some types of on-vehicle devices equipped with the car navigation systems, the program differential data is downloaded by use of a communication function of a mobile phone in a way that establishes a connection with the mobile phone (via a dedicated cable etc). Further, some types of on-vehicle devices include communication modules called DCMs dedicated to the on-vehicle devices. In FIG. 1, the mobile phone/DCM 2 stands for an aggregation of the mobile phone and the DCM as the communication interface with the center C1.

The deck 5 is a unit for reading update data of the program from an external storage medium such as a CD (Compact Disk) and a DVD (Digital Versatile Disc).

The master unit 3 includes at least one piece of microcomputer (which will hereinafter be abbreviated to “MC”). The master unit 3 performs a central role of handling the slave units 4. The master unit 3 is only the single unit existing in the on-vehicle device 1. A control computer such as the master unit 3 dedicated to the on-vehicle device is called an ECU (Electronic Control Unit) as the case may be.

The master unit 3 includes a communication unit 31, a download selection unit 32, a version information collecting unit 33, a program update unit 34, a slave communication unit 35, an HDD (Hard Disk Drive) 36, a DRAM (Dynamic Random Access Memory) 37 and an FROM (Flash Read Only Memory) 38.

The communication unit 31 (corresponding to an [acquiring unit]) receives the update data via the mobile phone/DCM 2 or the deck 5, and stores the update data in the HDD 36.

The download selection unit 32 selects which unit, the mobile phone/DCM 2 or the deck 5, the update data is downloaded from. For example, the download selection unit 32 detects that the CD or the DVD is inserted into the deck 5, and selects the deck 5 as the unit from which the update data is downloaded.

The version information collecting unit 33 manages a version of the programs installed into the current master unit 3.

The program update unit 34 (corresponding to an [update unit]) executes a program updating process based on the downloaded update data. A detail of the program update unit 34 will be described later on.

The slave communication unit 35 connects with the slave units 4 and performs the communication with the slave units 4. The connection between the master unit 3 and the slave units 4 is established by LAN (Local Area Network) wiring or a bus connection, for example.

The HDD 36 is an auxiliary storage device retaining the program executed on the on-vehicle device 1, related data, etc. FIG. 1 illustrates the diagram in which the master unit 3 includes the HDD 36. The HDD 36 may also be provided within the on-vehicle device 1 independently of the master unit 3 and the slave units 4.

The DRAM 37 is a main storage device. The DRAM 37 retains a loader program for loading the program stored in the HDD 36. When starting up a certain program, the loader program develops, on the DRAM 37, the program data of the certain program stored in the HDD 36.

The FROM 38 is a nonvolatile storage device. The FROM 38 retains a boot program and a boot flag. The boot program is a program including a startup process on the occasion of starting up (the computer of) the on-vehicle device 1 by switching ON a power source. The boot flag retains a flag which indicates the program folder loaded the programs. Details of the boot flag will be described later on.

The slave units 4 individually perform their unique functions. The slave units 4 are exemplified by digital TV equipment, a DVD reproducing device, etc. The number of the slave units 4 to be installed changes depending on the specifications of the on-vehicle device 1.

If the slave unit 4 deals with a large quantity of data as in the case of, for example, the digital TV equipment, the slave unit 4 might include a plurality of MCs because of a large load being applied onto one MC. If the slave unit 4 includes the plurality of MCs, the plurality of MCs is separated into one MC as a parent MC and other MCs as child MCs. The child MC receives the update data from the master unit via the parent MC.

Each of the slave units 4 include device communication unit 411, program update unit 412, and version information collecting units 413 in common. In the slave unit 4 having the plurality of MCs, the parent MC includes the device communication unit 411, the program update unit 412, and the version information collecting unit 413. The slave unit 4 has, in the case of including the plurality of MCs, a communication unit via which the parent MC and the child MCs perform the communications with each other. The child MC includes a communication unit 421 defined as a communication interface with the parent MC and a program update unit 422.

The device communication unit 411 is an interface connecting with the master unit 3. The device communication unit 411 connects with the master unit 3 via, for example, the LAN wiring, the bus connection, etc.

The version information collecting unit 413 manages the version information of the programs used by the parent MC and the child MCs within the slave unit 4. The version information collecting unit 413 compares the update data of the program downloaded by the master unit 3 with the version of the program executed by the slave unit.

The program update unit 412 and the program update unit 422 execute the respective program update processes of the parent MC and the child MCs of the slave unit 4 based on the update data downloaded by the master unit 3. The program update unit 412 and the program update unit 422 will be described later on.

The communication unit 31, the download selection unit 32, the version information collecting unit 33, the program update unit 34 and the slave communication unit 35 of the master unit 3 are, for example, CPUs (Central Processing Units) and IC chips including dedicated electronic circuits of the respective function units of the microcomputers, which are provided in the master unit 3. The device communication unit 411, the program update unit 412, the program update unit 422, the version information collecting unit 413 and the communication units 414, 422 of the slave unit 4 are, for example, the CPUs and the IC chips including the electronic circuits of the parent MC and the child MCs, which are provided in the slave unit 4.

### Example of Operation of Program Update System

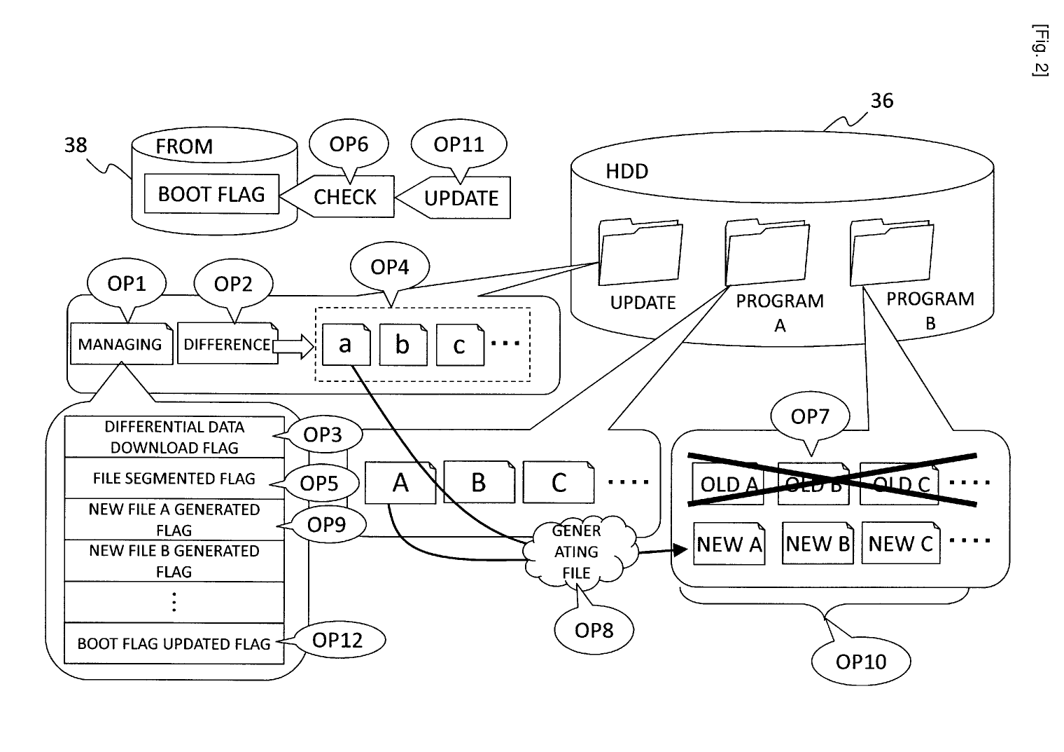

FIG. 2 is a diagram illustrating an example of operation in the program update process of a program update system. A discussion in FIG. 2 exemplifies a case in which the master unit 3 as a representative executes the program update process. An update folder, a program folder A, and a program folder B are set in the HDD 36. The update folder includes files related to the program update. The program folder A and the program folder B include all of the programs (which will hereinafter be referred to as a “program group”) used by the master unit 3. In FIG. 2, the discussion will proceed on such an assumption that the program folder A includes the program group of a version 2, while the program folder B includes the program group of a version 1 older than the version 2 of the program group stored in the program folder A.

The program update unit 34 of the master unit 3 generates a management file within the update folder in the HDD 36 (OP 1). At this point of time, the management file is empty.

The download selection unit 32 selects an event that the update data is downloaded from the mobile phone/DCM 2 or an event that the update data is read from the deck 5, and gives an indication to the communication unit 31. The communication unit 31 selects the event indicated by the download selection unit 32 and downloads the differential data file (OP 2). The downloaded differential data file is saved in the update folder in the HDD 36.

Note that the differential data is the differential data between the program retained by the center C1 or retained on the external storage medium such as the CD and the DVD and the program group of the latest version in the program groups stored in the program folder A or the program folder B. The version information collecting unit 33 manages the versions of the program groups stored in the program folder A and the program folder B. In the case of downloading the differential data from the center C1 via the mobile phone/DCM 2, the center C1 is notified of the latest version in the versions managed by the version information collecting unit 33 and generates the differential data from the program of the latest version. In the case of acquiring the differential data from the external storage medium such as the CD-ROM/DVD-ROM via the deck 5, the communication unit 31 reads only the differential data between the program of the latest version in the versions managed by the version information collecting unit 33 and the program of the version, which is stored on the external storage medium.

Upon completion of saving the differential data file in the update folder, the program update unit 34 records a completion of downloading the differential data in a management file (OP 3). A method of recording in the management file involves, for example, setting a “differential data download flag” indicating the completion of downloading the differential data in the management file.

Next, the program update unit 34 fragments the downloaded differential data file into differential data files (sub-files) on a per-module basis (OP 4). When generating the differential data files on the per-module basis, the program update unit 34 records completion of segmenting the downloaded differential data file in the management (OP 5). A method of recording in the management file involves, for example, setting a “file already-fragmented flag” indicating the completion of segmenting the downloaded differential file in the management file.

The program update unit 34 checks a boot flag in the FROM 38 and thus determines an update target program folder (OP 6). The boot flag retains a flag indicating which folder, the program folder A or the program folder B, is currently valid. For example, an assumption is that the program folder A is currently valid. If the program folder A is valid at the present, this implies that the program group stored in the program folder A has the latest version of the program installed in the master unit 3. Accordingly, if it proves from the boot flag that the program folder A is the currently valid folder, the program update unit 34 determines, as the update target folder, the program folder B retaining the program group of the older version.

The program update unit 34 deletes all the files stored in the update target program folder B (OP 7). The program update unit 34 newly generates, in the program folder B, a program file from the file in the update non-target program folder A and from the differential data file (OP 8). For instance, the program update unit 34 generates, in the program folder B, a new file A from a file A within the program folder A and a differential data file a. When the generation of the new file A is completed, the program update unit 34 records in the management file completion of generating the new file A (OP 9). A method of recording in the management file involves, for example, setting a “new file A generated flag” indicating the completion of generating the new file A.

The program update unit 34 repeats the processes in OP 8 and OP 9 a number of times corresponding to the number of the files stored in the program folder A (OP 10).

Upon the completion of the generation of the new file with respect to all of the files stored in the program folder A, the program update unit 34 sets the boot flag in FROM 38 to indicate the valid program folder is the program folder B (OP 11). The program update unit 34 records completion of updating the boot flag in the management file (OP 12). A method of recording in the management file involves, for example, setting a “boot flag updated flag” indicating the completion of updating the boot flag.

The operation checked program folder which has been used just before the update, can be retained as the backup by preparing two program folders including the program groups and updating only the program folder including the program group of the old version.

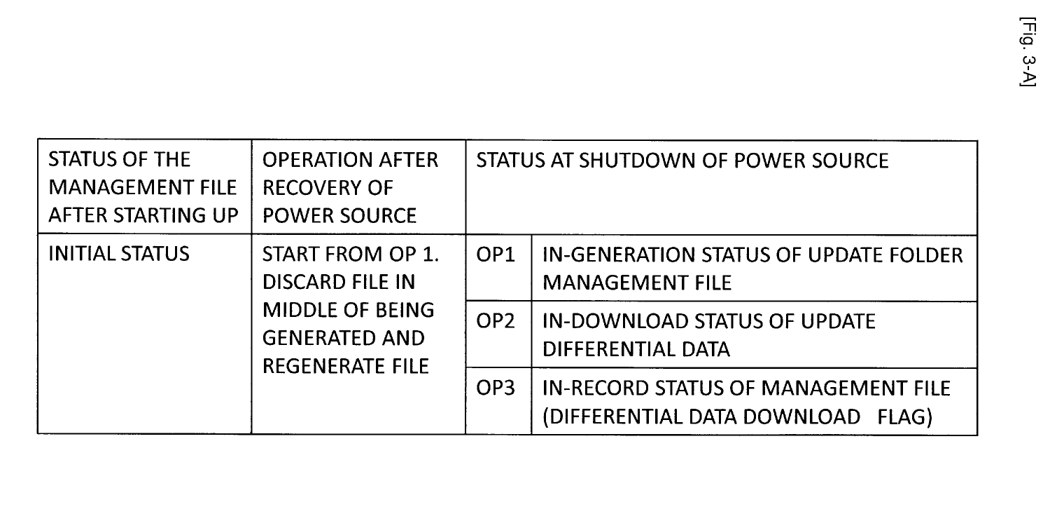

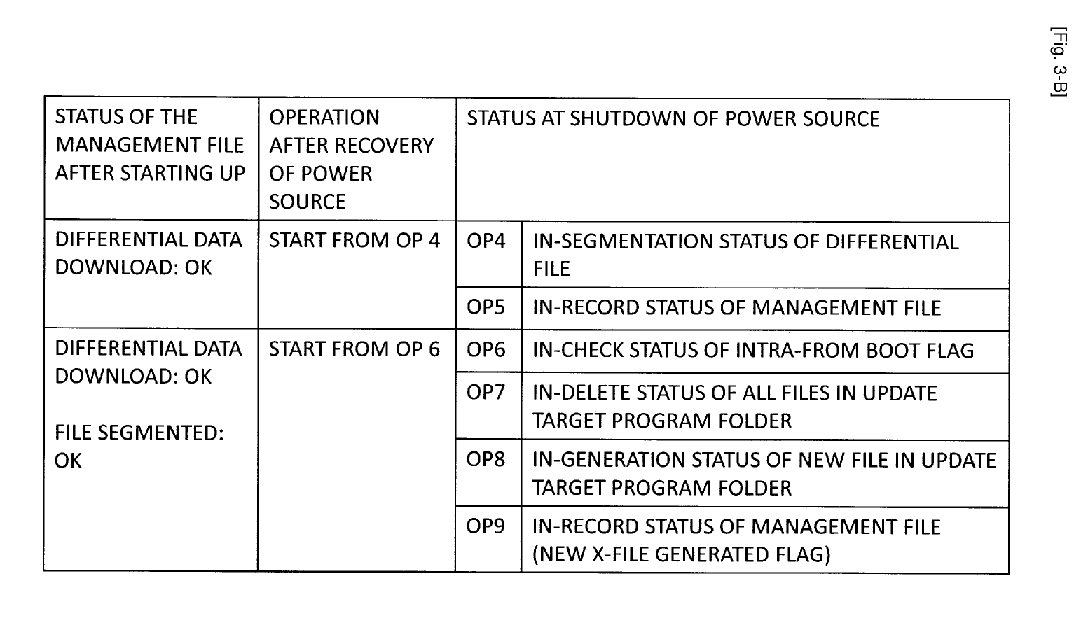

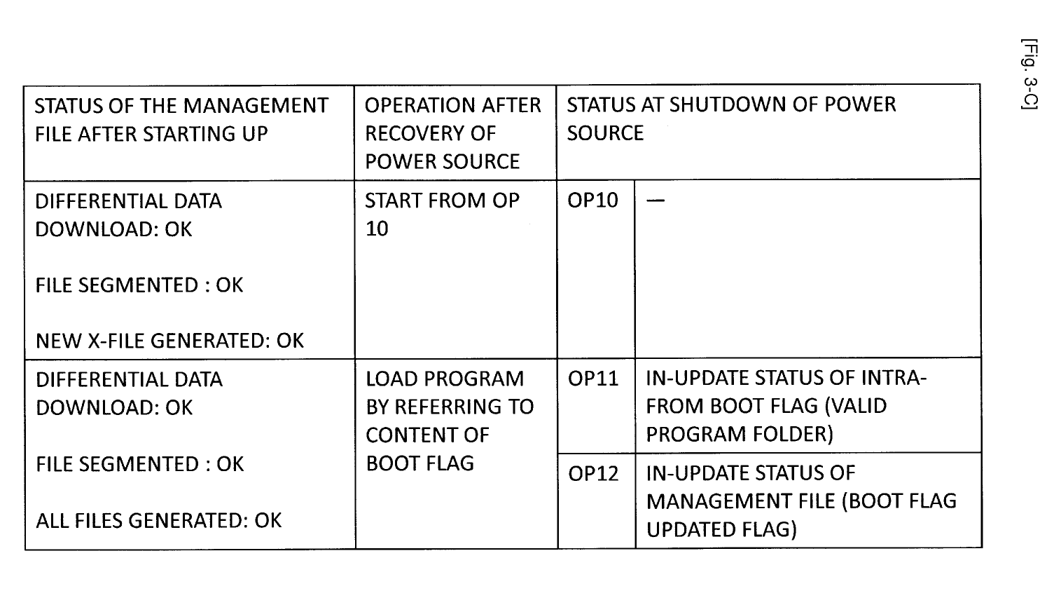

FIGS. 3A, 3B, and 3C are tables each illustrating an example of a recovery operation if a shutdown of the power source occurs during the processes in OP 1 through OP 12 explained in FIG. 2. FIGS. 3A, 3B, and 3C illustrate a recovery operation of the program update process in such a case that the power source (an accessory power source of the automobile) of the on-vehicle device 1 is switched OFF due to some factor with the result that the program update process is forcibly terminated, and thereafter the on-vehicle device 1 is started up.

After the on-vehicle device 1 has been started up, if the content of the management file in the update folder is in an initial status (null), the program update unit 34 starts the process from OP 1. If the content of the management file is in the initial status, the in-process status of generating the management file (OP 1), the in-download status of the differential data (OP 2), the in-record status of the differential data being already downloaded in the management file (OP 3) can be considered as the statuses in which the shutdown of the power source occurs. Alternatively, the status concerned is considered to occur in between the respective processes in OP 1 through OP 3. Therefore, when the content of the management file is in the initial status, the program update unit 34 starts the process from OP 1. Then, if the file (the management file, the differential data file) in the middle of being generated exists, the program update unit 34 temporarily discards the file in the middle of being generated and regenerates the file.

If the completion of downloading the differential data is recorded as the content of the management file, or, if the “differential data download flag” is set in the management file, the program update unit 34 starts the process from OP 4. In this case, any one of the in-generation status of the differential data files (sub-files) on the per-module basis by segmenting the differential data file (OP 4) and the in-record status of the segmented differential data files on the per-module basis in the management file (OP 5) is considered to exist as the status in which the shutdown of the power source occurs. Alternatively, the status concerned is considered to occur during a transition among the respective processes in OP 3 through OP 5. Hence, if the completion of downloading the differential data is recorded as the content of the management file, the program update unit 34 starts the process from OP 4.

If the completion of downloading the differential data and the completion of segmenting the downloaded differential data are recorded as the content of the management file, or, if the “differential data download flag” and the “file segmented flag” are set, the program update unit 34 starts the process from OP 6. In this case, any one of the in-check status of the boot flag in the FROM 38 (OP 6), the in-delete status of all the files in the update target program folder (OP 7), the in-generation status of the new file in the update target program folder (OP 8), and the in-record status of the new file being already generated in the management file (OP 9) is considered as the status in which the shutdown of the power source occurs. Alternatively, the status concerned is considered to occur during the transition among the respective processes in OP 5 through OP 9. Therefore, if the completion of downloading the differential data and the completion of segmenting file are recorded as the contents of the management file, the program update unit 34 starts the process from OP 6.

If the completion of downloading the differential data, the completion of segmenting the file and completion of generating a new X-files (X: variable) are recorded as the contents of the management file, or, if the “differential data download flag”, the “file segmented flag” and a “new X-files generated flag” are set, the program update unit 34 starts the process from OP 10. Namely, the program update unit 34 starts the process from generating the next new file in the new X-files. In this case, any one of the in-generation status of the new file in the update target program folder and the in-record status of the new file being already generated in the management file is considered to be the status in which the shutdown of the power source occurs. Hence, if the completion of downloading the differential data, the completion of segmenting the file, and the completion of generating the new X-files are recorded as the contents of the management file, the program update unit 34 starts the process from generating the next new file in the X-files.

If the completion of downloading the differential data, the completion of segmenting the file, and completion of generating all the files are recorded as the contents of the management file, or, if the “differential data download flag”, the “file segmented flag”, and the “new X-files generated flag” are set with respect to all the files, the program update unit 34 refers to the boot flag in the FROM 38 and starts loading the program. In this case, any one of an in-update status of the valid folder in the boot flag in the FROM 38 (OP 11) and an in-record status of the boot flag being already updated in the management file is considered as the status if the shutdown of the power source occurs. Therefore, if the completion of downloading the differential data, the completion of segmenting the file, and the completion of generating all the files are recorded as the contents of the management file, the program update unit 34 refers to the details of the boot flag and loads the program.

A state of progress of the program update process is managed in the management file, thereby enabling the operation to resume from the process that was (presumed to be) forcibly terminated in a way that refers to the management file even if the program management process is forcibly terminated due to the shutdown of the power source, etc.

### Value Example of Boot Flag

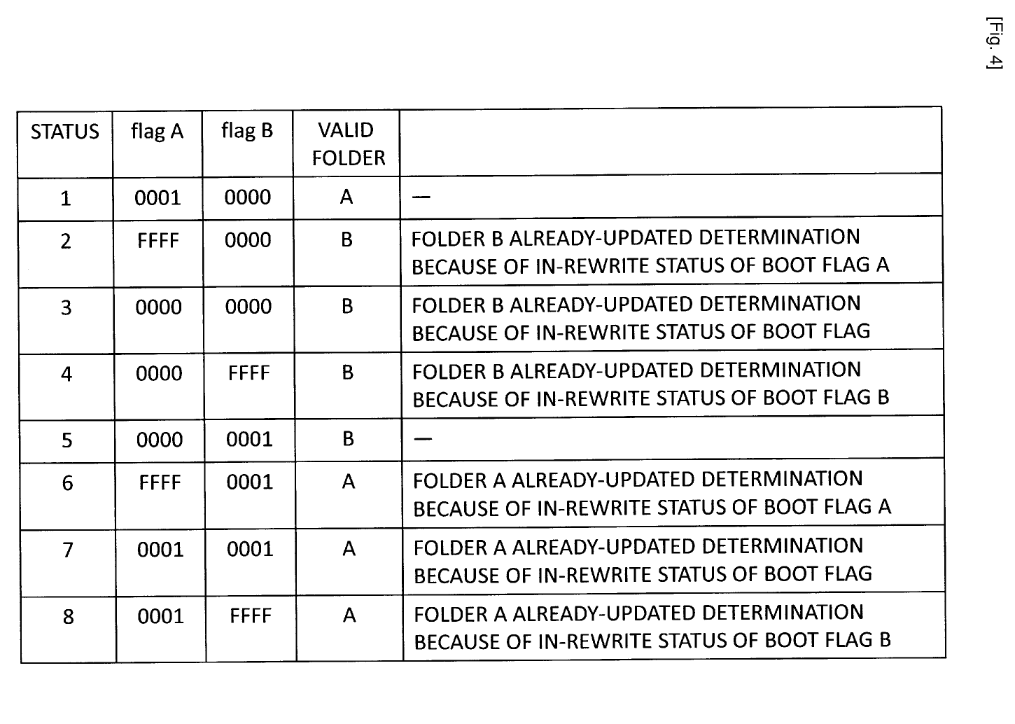

FIG. 4 is a table illustrating a value example of the boot flag in the FROM 38. For example, the boot flags are retained on a per-program-folder basis. To be specific, the boot flag A and the boot flag B are retained in the FROM 38, thereby selecting the program folder (indicating the valid program folder) that should be loaded when in a loading process.

FIG. 4 illustrates an example in which each of the boot flag A representing a status of the program folder A and the boot flag B representing a status of the program folder B consists of 16 bits. In FIG. 4, a value of each boot flag is expressed by the hexadecimal notation. In each boot flag, “0x0000” represents “invalid”, while “0x0001” represents “valid”. A characteristic of the FROM 38 is that the data in the boot flag needs temporarily invalidating in the case of rewriting (updating) the boot flag, and hence the data is cleared into “0Xffff”. Further, FIG. 4 illustrates a case where as for the update of the boot flag, the program folder A is updated in preference to updating the program folder B. As to the transition status of each of the boot flag A and the boot flag B, the boot flag is to transition from a status 1 via statuses 2, 3, 4 to a status 5, or alternatively from the status 5 via statuses 6, 7, 8 to the status 1.

The status 1 is a status in which the boot flag A is “0x0001”, and the boot flag B is “0x0000”. Namely, the status 1 represents the status in which the program folder A is selected as the valid program file at the present.

The status 2 is a status in which the boot flag A is “0xFFFF”, and the boot flag B is “0x0000”. This case implies that the boot flag A is in the middle of being rewritten, though the value in the boot flag B represents “invalid”, and the currently valid program folder is determined to be the program folder B in view of the boot flag A being in the process of being updated.

The status 3 is a status in which the boot flag A is “0x0000”, and the boot flag B is “0x0000”. In this instance, the status 3 indicates that both of the boot flag A and the boot flag B are in the process of being updated, and the program folder B is determined to be the valid program folder in view of a transition period to the status 5 from the status 1.

The status 4 is a status in which the boot flag A is “0x0000”, and the boot flag B is “0xFFFF”. The status 4 implies that the boot flag B is in the middle of being rewritten. The program folder B is determined to be the currently valid program folder in view of the boot flag A being preferentially updated.

The status 5 is a status in which the boot flag A is “0x0000”, and the boot flag B is “0x0001”. In this case, the program folder A is invalid, while the program folder B is valid.

The status 6 is a status in which the boot flag A is “0xFFFF”, and the boot flag B is “0x0001”. The boot flag A is in the middle of being rewritten, and it is determined in view of the transition from the status 5 that the program folder A is valid, while the program folder B is invalid.

The status 7 is a status in which the boot flag A is “0x0001”, and the boot flag B is “0x0001”. In this case, the status 7 indicates that both of the boot flag A and the boot flag B are in the process of being updated, and the program folder A is determined to be the valid program folder in view of the transition period to the status 1 from the status 5.

The status 8 is a status in which the boot flag A is “0x0001”, and the boot flag B is “0xFFFF”. The status 8 implies that the boot flag B is in the middle of being rewritten. The program folder A is determined to be the currently valid program folder in view of the boot flag A being preferentially updated.

When the on-vehicle device 1 is started up, the program is started after rewriting the value in the boot flag into the value in the status 5 in the case of the transition from the status 2 to the status 4 and into the value in the status 1 in the case of the transition from the status 6 to the status 8.

### Example of Startup Sequence

Upon completion of the program update process, the on-vehicle device 1 and the master unit 3 or each slave unit 4 are restarted, and the process of loading the program of the updated latest version is executed. At this time, even if the program update process gets successful, there is a possibility that an abnormal state might occur in the loading process of the program of the updated latest version, and so on. A bug existing in the update program might cause the abnormality of the loading of the program such as this, in which scrambles-bits, it is considered, occur when loading the update program onto the DRAM 37. Thus, if the updated program is not started, the on-vehicle device 1 in the first embodiment retains recovery data in the HDD 36 as a recovery means.

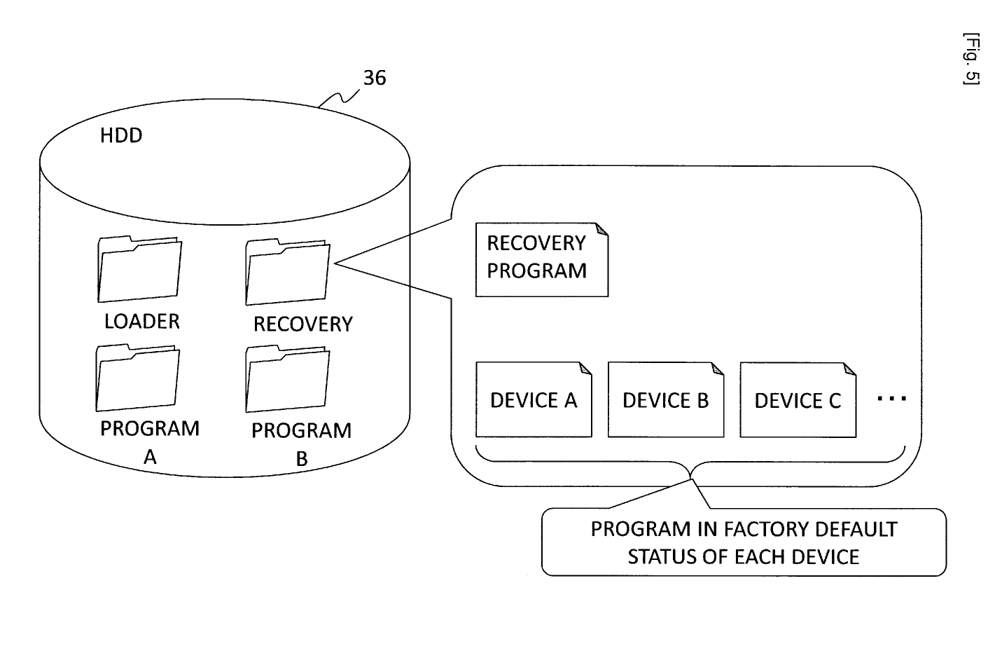

FIG. 5 is a diagram illustrating an example of how the recovery data of the on-vehicle device 1 is retained. The HDD 36 retains a loader folder and a recovery folder. The loader folder retains the loader program for executing the loading process. The recovery folder retains a recovery program and programs of the respective units (the master unit, the slave units) in a factory shipment status. The recovery program is a program for executing the recovery process.

### Example of Flow of Startup Operation at Normal Time

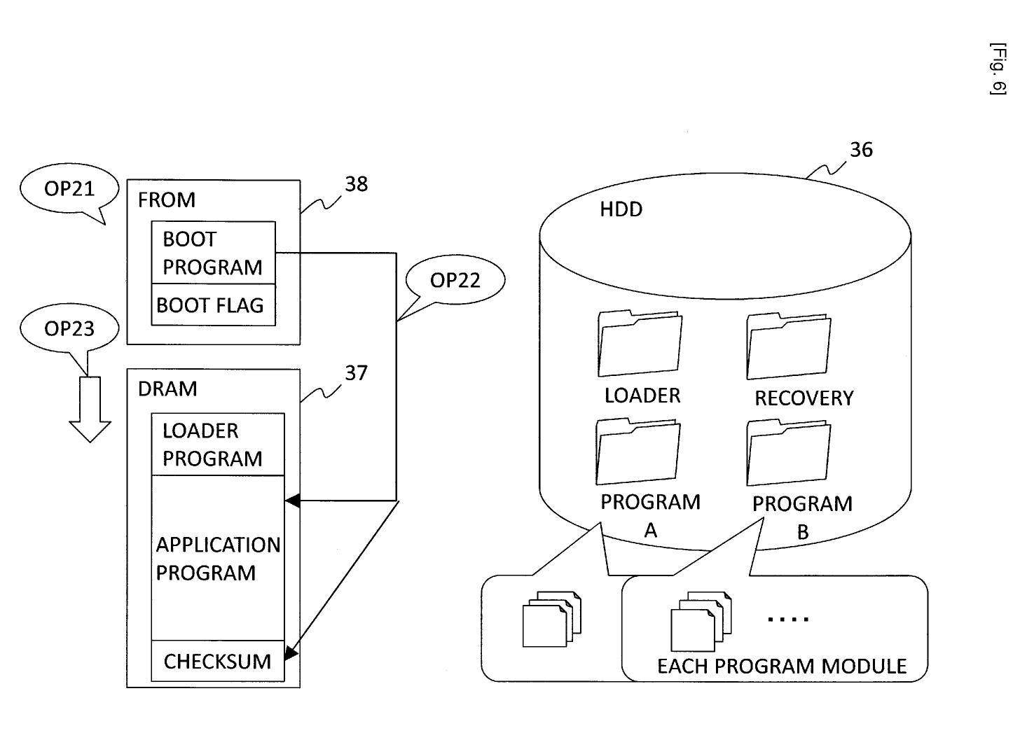

FIG. 6 is a diagram illustrating an example of a flow of a startup operation at the normal time. FIG. 6 illustrates a case in which the power source of the on-vehicle device 1 is switched ON, and the master unit 3 executes a startup sequence in a way that includes startup of the slave units 4. When the power source of the on-vehicle device 1 or the master unit 3 is switched ON, the boot program stored in the FROM 38 starts up (Op 21). The CPU executing the boot program detects an error of an application program loaded into the DRAM 37 (OP 22).

An error check of the application program involves detecting the error by the checksum, checking an abnormal reset occurrence count, and checking an abnormal loading occurrence count. The abnormal reset involves spontaneously resetting if the bug exists in the application program. An abnormal reset count is a count of how many times the application program is reset up to the startup of this time. The “abnormal loading” stands for a failure in the process of copying the application program stored in the HDD 36 to the DRAM 37. The abnormal loading count is a count of how many times the abnormal loading occurs up to the startup of this time.

If none of the abnormality is detected in the error check of the application program, the application program loaded into the DRAM 37 is thereafter executed (OP 23).

At the normal time, the CPU does not refer to the program folder stored in the HDD 36 but starts up by use of the data of the application program loaded into the DRAM 37.

### Example of Operation at Startup Time in Case of Occurrence of Abnormality

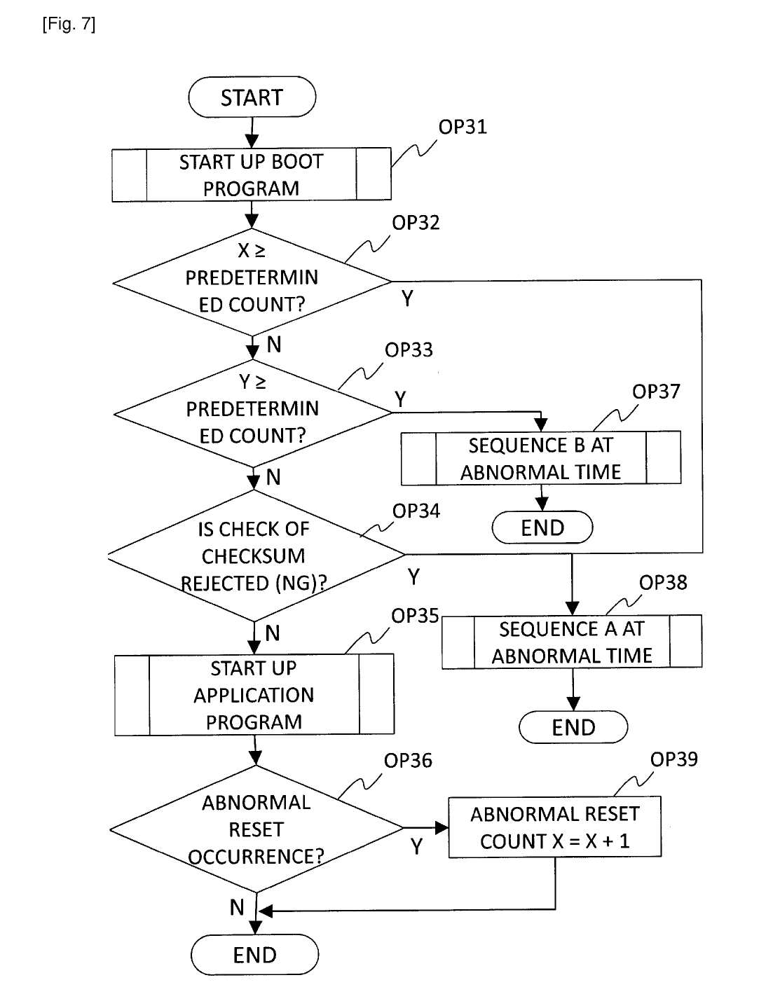

FIG. 7 is a flowchart illustrating an example of the startup sequence. FIG. 7 also illustrates, similarly to FIG. 6, a case in which the master unit 3 performs the startup sequence.

When the power source of the on-vehicle device 1 or the master unit 3 is switched ON (alternatively the on-vehicle device 1 or the master unit 3 is restarted up), the boot program stored in the FROM 38 is started (OP 31).

The CPU of the master unit 3 checks an abnormal reset count X of the application program, which is recorded in a log (OP 32). The CPU checks whether or not the abnormal reset count X of the application program is equal to or larger than a predetermined count that is set beforehand. If the abnormal reset count X of the application program takes a value equal to or larger than the predetermined count (OP 32: Y), the process shifts to a sequence A at the abnormal time (OP 38). The sequence A at the abnormal time will be described later on.

If the abnormal reset count X of the application program takes the value smaller than the predetermined value (OP 32: N), the CPU determines whether or not an abnormal loading count Y takes a value equal to or larger than a predetermined count that is set beforehand (OP 33). If the abnormal loading count Y takes the value equal to or larger than the predetermined count (OP 33: Y), the process shifts to a sequence B at the abnormal time (OP 37). The sequence B at the abnormal time will be explained later on.

If the abnormal loading count Y of the application program is smaller than the predetermined count (OP 33: N), the CPU checks the checksum (OP 34). If the abnormality is detected in the checksum (OP 34: Y), the process shifts back to the sequence A at the abnormal time (OP 38). Where as if the abnormality is not detected in the checksum (OP 34: N), the CPU starts up the application program (OP 35).

The CPU monitors the occurrence of the abnormal resetting of the application program and, if the abnormal resetting occurs (OP 36), adds “1” to the abnormal reset count X, thus recording the occurrence of the abnormal resetting (OP 39).

### Sequence A at Normal Time

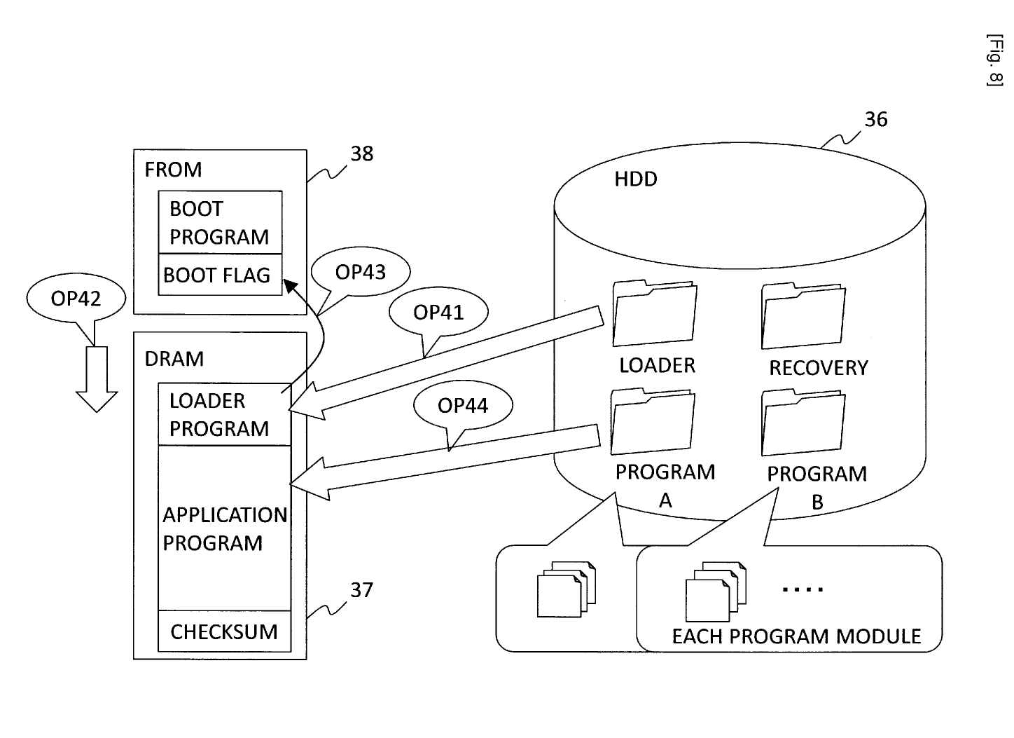

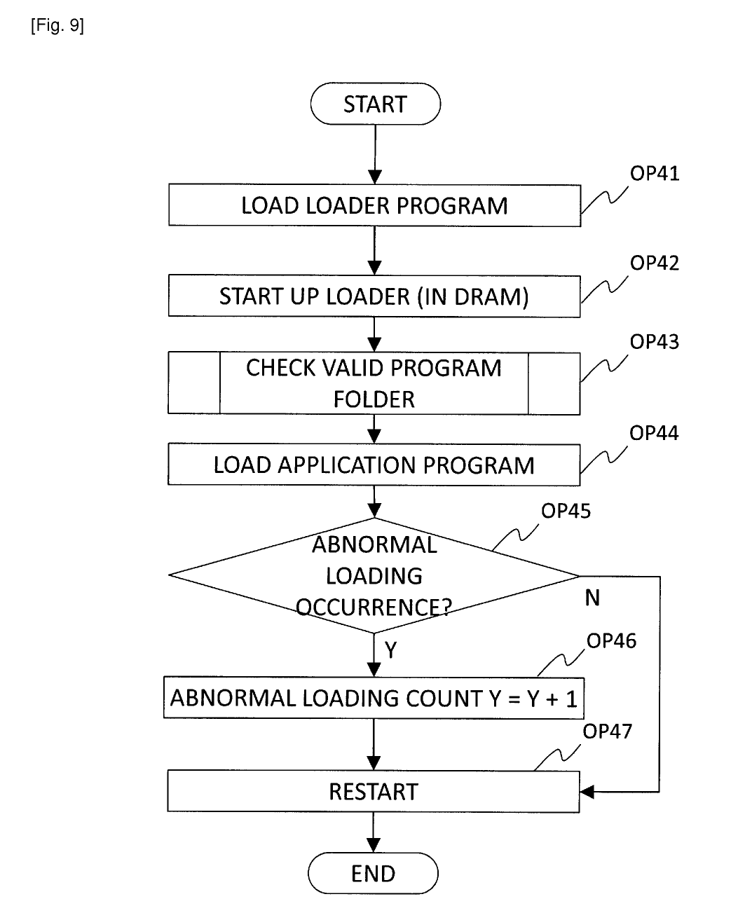

FIG. 8 is a diagram illustrating the sequence A at the abnormal time, or, a processing flow executed if the abnormal reset count X takes the value equal to or larger than the predetermined count and if the abnormality is detected in the checksum. FIG. 9 is a flowchart illustrating a processing flow of the sequence A at the abnormal time. In FIGS. 8 and 9, the same processes are marked with the same numerals and symbols.

If the abnormal reset count X takes the value equal to or larger than the predetermined count and if the abnormality is detected in the checksum, the loader program loaded into the DRAM 37 is reloaded from the loader folder in the HDD 36 (OP 41). Next, the reloaded loader program is started up (OP 42).

The CPU, based on the started-up loader program, checks the boot flag in the FROM 38, and acquires the currently valid program folder (OP 43). The CPU reloads the application program from the currently valid program folder stored in the HDD 36 (OP 44).

If the abnormal state occurs when loading the application program (OP 45: Y), the CPU adds “1” to the abnormal loading count Y, and records the occurrence of the abnormal loading (OP 46). Thereafter, the CPU restarts up the program, thereby executing again the processes illustrated in FIG. 7 (OP 47).

In the case of succeeding in loading the application program (OP 45: N), the program is restarted up, and the processes illustrated in FIG. 7 are again executed (OP 47).

### Sequence B at Abnormal Time

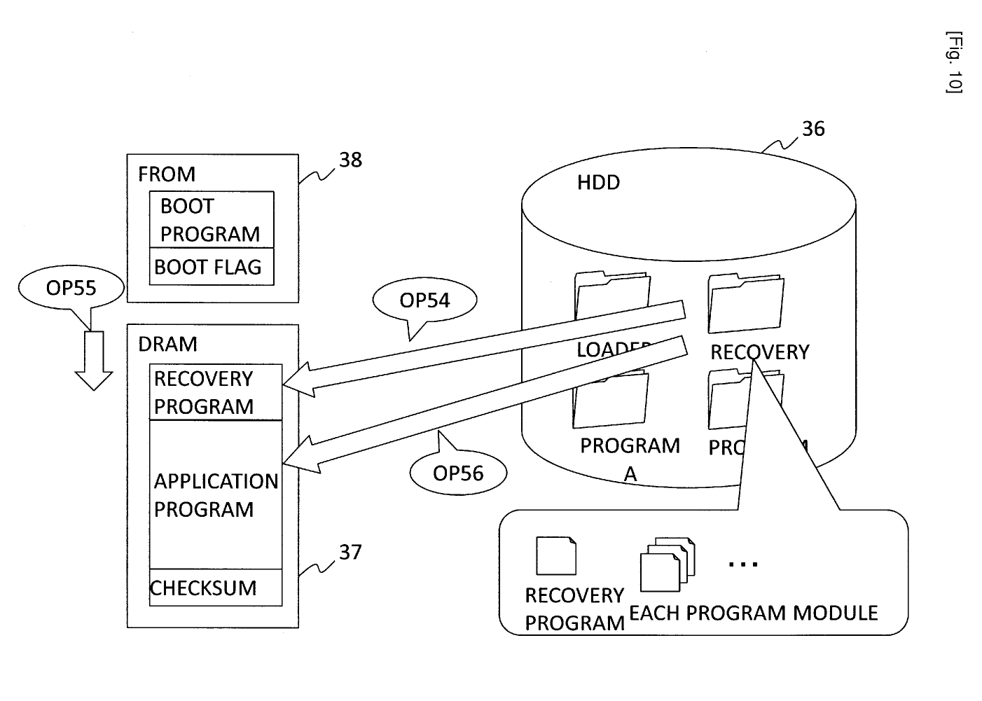

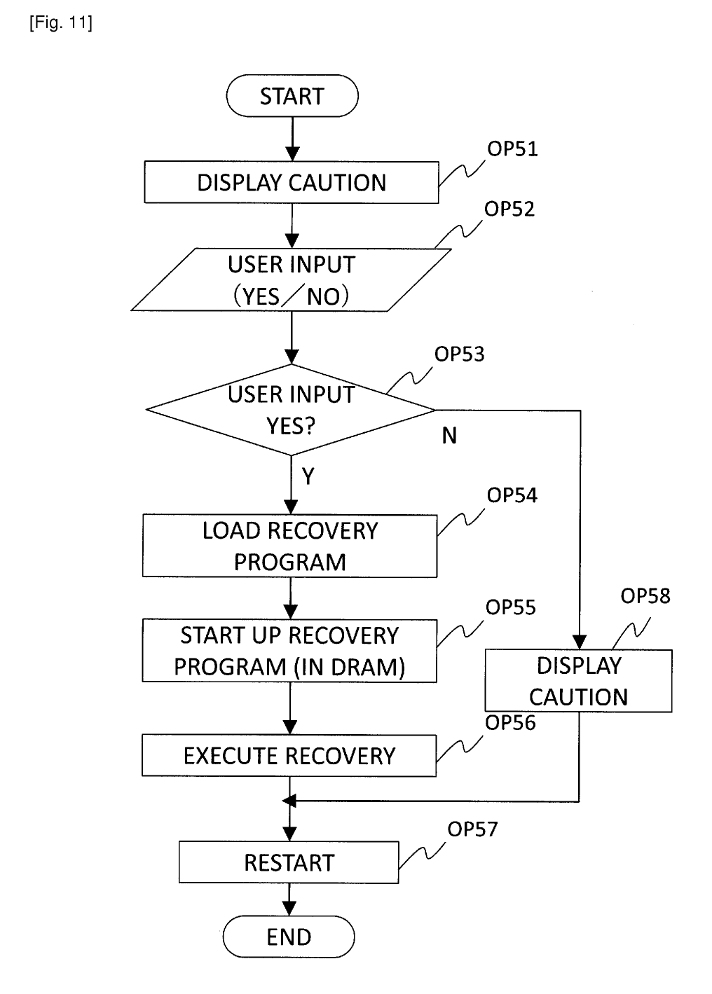

FIG. 10 is a diagram illustrating the sequence B at the abnormal time, or, processes executed if the abnormal loading count Y takes the value equal to or larger than the predetermined count. FIG. 11 is a flowchart illustrating a processing flow of the sequence B at the abnormal time. In FIGS. 10 and 11, the same processes are marked with the same numerals and symbols.

If the abnormal loading count Y takes the value equal to or larger than the predetermined count, the CPU displays a caution for querying the user of the on-vehicle device 1 about whether the recovery process is executed or not (OP 51). The caution displayed has a content for getting confirmation about the execution of the recovery process from the user, such as “The program is disabled from starting up due to the abnormality of the program file. The program is reset to the factory shipment status. All right? (YES/NO)”.

The user performs inputting in response to the caution display (OP 52). When the user selects the execution of the recovery process (OP 53: Y), the CPU loads the recovery program from the recovery file in the HDD 36 (OP 54). The CPU starts up the loaded recovery file (OP 55), and loads the application program in the factory shipment status from the recovery folder in the HDD 36 (OP 56). Thereafter, the CPU restarts up the program and executes again the processes illustrated in FIG. 7 (OP 57).

If the user does not select the execution of the recovery process (OP 53: N), the CPU displays a caution purporting that the system is rebooted (OP 58). The caution displayed at this time has a content of obtaining the confirmation of the rebooting from the user such as [The system is rebooted]. Thereafter, the system is rebooted and executes again the processes illustrated in FIG. 7 (OP 57).

### Operational Effect of First Embodiment

The two folders retaining the programs are retained, and, in the case of executing the program update process, only any one of the program folders is updated. The other program folder is retained as the backup. This will be no lost of the data of the original program with its operation being guaranteed, even if the process is forcibly terminated due to the shutdown of the power source during the program update process.

In the program update process, the state of the progress is recorded in the management file, thereby enabling the resumption to be done from the process next to the process of recording the completion in the management file even if the program update process is forcibly terminated due to the shutdown of the power source. Accordingly, the program update process does not need doing again from the beginning, and the time can be saved.

The master unit 3 downloads batchwise the update programs of the slave units 4. On the occasion of executing the program update process of the slave unit 4, a dedicated jig is required as the case may be. The operations of updating the programs are unified into the master unit 3, whereby the user can perform the program update process of the slave unit 4 even without the dedicated jig.

The occasion of downloading the update program from the center C1 involves downloading only the differential data between the program retained by the on-vehicle device 1 and the program of the new version that is retained by the center C1. This will reduce the traffic between the center C1 and the on-vehicle device 1 and the data downloading time. In the case of the communications in a pay-as-you-go (usage based rate) system for packet communications etc, the communication fee will be restrained.

When started (booted) up, the startup (boot) method is determined by checking three types of parameters such as the checksum of the application program in the DRAM, the abnormal reset count, and the abnormal loading count. This startup method enables the recovery to be executed stepwise, which has high efficiency. Further, since all the programs in the factory shipment status are stored within the recovery folder, the full-recovery to the factory shipment status can be attained, and the startup is guaranteed.

According to the first embodiment, the user himself or herself can perform the program update process, and, even when getting into a startup-disabled status due to the interruption of the program update process and the failure in the program update process, the system can be recovered to the normal status.

### Modified Example

Tow management files are prepared as in the case of the program files and may thus be duplexed. For example, when starting the program update process, a copy of the management file A in the update folder is generated. This copy file of the management file A is used as a management file B. The management file A is retained in a status quo, while the management file B is updated in the program update process. Just when completing the program update process, the management file A is deleted. With this contrivance, even if the shutdown of the power source occurs during the program update process, the management file can be retained as the backup, and it is therefore feasible to prevent the contents of the management file from being lost.

Moreover, if the shutdown of the power source occurs in the process of updating the management file B, for example, the management file suited to the case of the resumption of the process can be selected by making the determination as follows.

(1) If the management file A exists but the management file B does not exist, the reference to the management file A is made.

(2) If both of the management file A and the management file B exist, the reference to the management file A is made, while the management file B is deleted.

(3) If the management file A does not exist but the management file B exists, the reference to the management file B is made.

The first embodiment has discussed the process of updating batchwise the program group stored in the program folder. In place of this scheme, the individual programs can be also updated. In the case of designating and updating the individual programs, the program stored in the valid program folder indicated by the boot flag is updated. Upon the completion of the update, with respect to the updated program, the event of the program being already updated is recorded in the management file.

According to the first embodiment, in the sequence B at the abnormal time, the program in the factory shipment status is loaded from the recovery folder. A substitute for this scheme is that in the sequence B at the abnormal time, the boot flag is checked, and the currently invalid program folder, i.e., the pre-update program of the old version having the operating results may also be loaded.

Further, the first embodiment has discussed the case in which the master unit 3 executes the program update process of each slave unit 4 and the recovery process. The present invention is not limited to this case, each of the slave units 4 may also execute the program update process and the recovery process in the application program used by the slave unit 4 itself.

### REFERENCE SIGNS LIST

1 on-vehicle device
2 mobile phone/DCM
3 master unit
4 slave unit
5 deck
31 communication unit
32 download selection unit
33 version information collecting unit
34 program update unit
35 slave communication unit
36 HDD
37 DRAM
38 FROM
41 parent microcomputer (MC)
42 child MC
411 device communication unit
412 program update unit
413 version information collecting unit
414 communication unit
421 communication unit
422 program update unit

1. A program update device comprising:
a first storage unit to retain a program of a first version;
a second storage unit to retain a program of a second version equal to or later than the first version;
an acquiring unit to acquire a difference between the program of the second version and a program of a third version later than the second version; and
an update unit to generate the program of the third version from the program of the second version that is stored in the second storage unit and the difference acquired by the acquiring unit, and to store the generated program of the third version in the first storage unit.

2. The program update device according to claim 1, further comprising a storing unit to retain information indicating which, the first storage unit or the second storage unit, retains the program for use,
wherein the update unit generates the program of the third version from the acquired difference and the program of the second version that is stored in the second storage unit, and updates, if the generated program of the third version is stored in the first storage unit, the information retained by the storing unit into information indicating that the program stored in the first storage unit is used.

3. The program update device according to claim 1, further comprising a management information storage unit to retain management information indicating completion of each of a process of acquiring the difference, a process of generating the program of the third version, and a process of storing the generated program of the third version in the first storage unit,
wherein the update unit, when completing each of the process of acquiring the difference, the process of generating the program of the third version, and the process of storing the generated program of the third version in the first storage unit, stores the management information indicating the completion of the process in the management information storage unit, and, when a series of these processes are interrupted, executes the process not given the indication of the completion of the process based on the management information stored in the management information storage unit.

4. A program update method executed by a computer comprising:
a first storage unit to retain a program of a first version; and
a second storage unit to retain a program of a second version equal to or later than the first version;
the method comprising:
acquiring a difference between the program of the second version and a program of a third version later than the second version;
generating the program of the third version from the program of the second version that is stored in the second storage unit and the acquired difference; and
deleting the program of the first version that is stored in the first storage unit, and storing the generated program of the third version in the first storage unit.

5. An information processing device comprising:
an auxiliary storage device to retain a program of a version set when shipped from a factory and a program of a first version later than the version at the factory shipment time;
a main storage device to retain the program of the first version that is loaded from the auxiliary storage device; and
a CPU to start up the program of the first version that is retained by the main storage device with power on,
wherein the CPU, when an error exists in the program of the first version that is retained by the main storage device and when an operation of the program of the first version that is retained by the main storage device is interrupted a predetermined number of times or more during a period till power on, loads the program of the first version that is stored in the auxiliary storage device into the main storage device, and
the CPU, when the program of the first version that is retained by the main storage device fails to be loaded a predetermined number of times or more during the period till power on, loads the program of the version at the factory shipment time that is stored in the auxiliary storage device into the main storage device.
